(19) United States
(12) Patent Application Publication
(10) Pub. No.: US 2016/0104582 A1
(43) Pub. Date: Apr. 14, 2016

(54) PERIODIC NANOSTRUCTURES FOR HIGH ENERGY-DENSITY AND HIGH POWER-DENSITY DEVICES AND SYSTEMS AND USES THEREOF

(71) Applicant: Texas Tech University System, Austin, TX (US)

(72) Inventor: Shiren Wang, Lubbock, TX (US)

(73) Assignee: TEXAS TECH UNIVERSITY SYSTEM, Lubbock, TX (US)

(21) Appl. No.: 14/823,145

(22) Filed: Aug. 11, 2015

Related U.S. Application Data
(60) Provisional application No. 62/035,868, filed on Aug. 11, 2014.

(51) Int. Cl. H01G 11/36; H01G 11/26; H01G 11/86; H01G 11/58

(52) U.S. Cl. CPC H01G 11/36; H01G 11/58; H01G 11/26; H01G 11/86

(57) ABSTRACT

Periodic nanostructures for high energy-density and high-power density device and systems and uses thereof. Hierarchical nanostructured materials having stacked polymer nanowires forests interconnected by monolayer graphene sheets were fabricated through bottom-up nanofabrication. Driven by external voltage, aniline molecules and graphene oxide were alternatively assembled for hierarchical porous stacked nanostructures while graphene oxide was in-situ reduced to graphene during the assembly process. As-produced hierarchical nanostructures can be used as supercapacitor electrodes, which can utilize the discovered stack-dependent device properties.

### CROSS-REFERENCE TO RELATED PATENT APPLICATION

This application claims priority to: provisional U.S. Patent Application Ser. No. 62/035,868, filed on Aug. 11, 2014, entitled “Periodic Nanostructures For High Energy-Density and High Power-Density Devices And Systems And Uses Thereof,” which provisional patent application is commonly assigned to the Assignee of the present invention and is hereby incorporated herein by reference in its entirety for all purposes.

### GOVERNMENT INTEREST

This invention was made with government support under Grant No. 1129914 awarded by the National Science Foundation. The government has certain rights in the invention.

### FIELD OF INVENTION

The present invention relates to systems and methods for energy storage. More particularly, the present invention relates to periodic nanostructures for high energy-density and high-power density device and systems and uses thereof.

### BACKGROUND OF INVENTION

Energy sustainability and storage has been a worldwide concern due to the depletion of the fossil fuel and environmental pollutions. [Smalley 2009]. As one of the next generation energy-storage devices, ultra-capacitors play a major role in future vehicles and microelectronics devices because of their stable cycling life, fast charging—discharging rate and intrinsically ultra-high power density. However, ultra-capacitors suffer from low energy density. Many efforts have been made to combine both high energy density and power density. A straightforward approach is to increase the operating voltage by employing organic electrolyte or ionic liquid. [Stoller 2008; Liu 2010; Zhu 2011]. However, because of the low ionic conductivity in the organic system, the equivalent series resistance rises to more than 10Ω, much larger than ˜1Ω in most of the aqueous systems. As a result, power density will deteriorate in organic electrolytes.

Another approach is to hybridize pseudo-capacitive materials with electro-double layer capacitive materials (such as graphene) to achieve both ultra-high surface area and high pseudo capacitances. [Wu 2010; Xu 2010; Kumar 2012; R. Wang 2012; Lee 2010; Li 2010; Li 2009]. The transition between oxidization/reduction states of the pseudo-capacitive materials could improve the energy density without deteriorating the power density. However, most hybrids are disordered in the long range and thus fail to achieve high specific energy-density and power-density at a large scale.

Design and fabrication of electrodes with an ordered structure emerges as a promising way for high-performance supercapacitors. Generally, tuning porous structures and orientation could facilitate the ion diffusion and thus lead to high energy and power density. Two different structures, orientated nanochannels and nanowires, have demonstrated significant advantages. Kajdos's study showed that improvement of pore alignment in zeolite-template synthesized carbon materials led to a 33% increment in capacitance. [Kajdos 2010]. Other efforts have also been reported on tailoring the pore radius and its distribution both theoretically and experimentally. [Largeot 2008; Huang 2008; Skinner 2011]. However, the improvement in power-density is limited since the electrolyte only diffused toward unidirectional tunnels.

In the other method, in-situ synthesized nanowires facilitate charge diffusion and transfer in both perpendicular and lateral directions, such as carbon nanotubes arrays [Wang 2013; Q. Li 2012], metal oxides [Liang 2010; Salari 2011; Lu 2011; Lu 2009; X Li 2012; Jiang 2011; Banerjee 2009; Xia 2012] and conjugated polymers arrays [Wang 2010; Xue 2012; Kuila 2009; Li 2013].

It is also easy to tune the alignment and diameter of the polymer nanowires to achieve significant enhancement in electrochemical performances. By reducing the nanowire diameter from 50 nm to 13.5 nm, the increment in specific capacitance was more than tripled [Wang 2010; Kuila 2009]. In addition, electrodes directly deposited on the current collector are especially desired because of low contact resistance and thus better high-frequency performance.

A supercapacitor demonstrates high power density, fast charge discharge rate, long cycling life, simple cell configuration and free from maintain [Wei 2012; Winter 2004]. Thus a supercapacitor is regarded as one of the most promising candidates for the next generation energy and power storage devices for various applications, such as electric vehicles, electronic devices, and electrochemical sensors. The emerging of the wearable and flexible electronics places a huge demand for the flexible energy storage devices. Solid-state supercapacitors have attracted great attentions due to the increasing concerns on robustness, safety, and flexibility of energy-storage systems. However, current solid-state supercapacitors exhibit limited energy density and power density; particularly, the performance is getting much worse in the high current and high frequency.

As a key component in the supercapacitor, electrode has been extensively studied. Because of the flexibility and high surface area, graphene, carbon nanotube and conjugated polymer electrode materials received a great attention. Vacuum filtration of graphene or carbon nanotube suspensions was used to prepare carbon nanostructure electrodes. Graphene is a capacitive material and the electric storage is only based on electric static attraction [Choi 2011]. In addition, filtration-produced graphene electrode shows limited surface area due to the stacking Carbon nanotubes or graphene-based solid-state supercapacitors ever demonstrate a 15.5 Wh/Kg [Kang I 2012]. Functionalization of graphene with pseudo-capacitive materials such as RuO can significantly increase the energy density, resulting in an energy density of 19.7 Wh/kg [Choi 2012]. Other metal oxides, such as MnO₂, were also used to functionalize graphene, but the resultant complexes are easily to be broken [Xiao 2012; Yuan 2012]. The high ionic resistant also deteriorates their performance at large current and high frequency. Conjugated polymers are considered as another promising candidate because of the high pseudocapacitance and tunable electric conductivity [ Wang 2011].

Various electrolyte/polymer hybrids have been studied as the potential solid-state electrolytes. Because of the hydrophobic characteristic of graphene, the ionic liquid/polyvinylidene difluoride (PVDF) systems are usually employed to ensure the favorable interface interaction between electrode and electrolytes [Yang 2013]. The ionic conductivity is critical for the solid-state supercapacitors, and thus many approaches have been studied to increase ionic conductivity in the ionic liquid electrolytes.

For instances, co-polymer and nanofillers were introduced to increase the ratio of amorphous phase and ionic path in the electrolyte [Yang 2013; Kang II 2012]. Considering inorganic proton acid/polyvinyl alcohol (PVA) complexes are much easier to prepare and also exhibit relatively higher ionic conductivity, as well as good compatibility with graphene, they are widely investigated to achieve more efficient interface charge transfer, energy density, and power density [Hu 2012; Jung 2012].

### SUMMARY OF INVENTION

The present invention relates to periodic nanostructures for high energy-density and high-power density device and systems and uses thereof. A hierarchical nanostructure has been discovered that includes stacked polymers interconnected by mono-layer graphene sheets, which was synthesized through a novel bottom-up nanofabrication process. The hierarchical nanostructure materials can be used as the electrode of a supercapacitor (including having aqueous or organic electrolytes).

The present invention has an innovative design and fabricates novel nanostructures with alternative stacks of nanowire array and graphene nanosheets. Applicants are unaware of any earlier design of such a novel structure. Typically, supercapacitors show very low energy density (usually<10 Wh/Kg) although high power density. Many attempts have been made to increase the energy density at the expense of the power density. The present invention presents an innovative solution for achieving high energy density and high power density simultaneously (Energy density>137 Wh/Kg, Power density>2000 W/Kg). Accordingly, the present invention provides for embodiments having an energy density above 75 Wh/Kg and simultaneously having a power density above 2000 W/Kg.

The unique design of multi-stack nanostructures of the present invention allows effectively integration of capacitive and pseudo-capacitive materials. The present invention further tailors the interactions between such a novel structure and electrolyte. Increasing the number of stacks can increase the energy density while retaining the power density. Again, Applicant is unaware of any prior effort utilizing such periodic stacked nanostructures.

Furthermore, multilayered structured polyaniline (PANI) nanowire were fabricated arrays-linked by graphene, and then incorporated into H₃PO₄-Nafion/PVA to form hybrid composites, which serve as solid state supercapacitors. The vertically aligned PANI nanowires with hydrophilic surface and small diameter could ensure the good wettability of the electrode and favorable interface charge transferring. Their performance at the high current density and high frequency were investigated.

Multilayered ordered nanostructures were fabricated by assembling in-situ grown polyaniline nanowire arrays with graphene oxide nanosheets. As-fabricated nanostructure was subsequently impregnated with the (H₃PO₄—Nafion)/polyvinyl alcohol solution to create a multiphase composite, which was used as a solid-state supercapacitor where graphene oxide/polyaniline nanowires served as electrode and (H₃PO₄—Nafion)/polyvinyl alcohol served as solid electrolyte. The ordered polyaniline (PANI) nanostructures facilitated the charge transfer and resulted in the specific capacitance of 83 F/g even if the discharge current was 5 A/g. The efficient charge transportation and electrode-electrolyte interaction resulted in small equivalent series resistance as low as 5.83Ω, and thus outstanding electrochemical performance. The charge transfer resistance was much smaller than other commonly used solid-state electrolyte and almost negligible. As a result, only 7% capacitance loss was found when the frequency increased from 100 to 1000 Hz. The energy density was as high as 26.5 Wh/kg while the power density was ˜3600 W/kg. The energy storage performance was also very stable since 82% specific capacitance was maintained after 1000 cycles.

In general, in one aspect, the invention features a composition that includes a plurality of stacked polymer nanowire arrays interconnected with graphene sheets.

Implementations of the invention can include one or more of the following features:

The graphene sheets can be mono-layer graphene sheets.

The stacked polymer nanowire arrays in the plurality of stacked nanowire arrays and the graphene sheets can be positioned alternatively.

The stacked polymer nanowire arrays can include polyaniline nanowire arrays.

The stacked polymer nanowire arrays can include polymer nanowires having diameters between 13.5 to 50 nm.

The stacked polymer nanowire arrays can include polymer nanowires having diameters between 20 to 30 nm.

The stacked polymer nanowire arrays can include polymer nanowires having diameters between 40 to 50 nm.

The composition can further include polyvinyl alcohol.

In general, in another aspect, the invention features a device including a material having a plurality of stacked polymer nanowire arrays interconnected with graphene sheets.

Implementations of the invention can include one or more of the following features:

The device can be operable for simultaneously having (a) an energy density at least 75 Wh/Kg and (b) a power density of at least 1500 W/Kg.

The device can be operable for simultaneously having (a) an energy density between 75 Wh/Kg and 150 Wh/Kg and (b) a power density of between 1500 W/Kg and 65,000 W/Kg.

The can be operable as a supercapacitor.

The device can further include an aqueous electrolyte.

The device can further include an organic electrolyte.

The device can be operable for having a specific capacitance between 75 F/g and 250 F/g.

The stacked polymer nanowire arrays can include polyaniline nanowire arrays.

The material can further include polyvinyl alcohol.

In general, in another aspect, the invention features a method that includes (a) preparing a first layer of a polymer nanowire array. The method further includes (b) depositing a first layer of graphene oxide on the first layer of the polymer nanowire array to form a first material. The method further includes (c) fabricating a second layer of the polymer nanowire array on the first material to form a second material. The method further includes (d) depositing a second layer of graphene oxide on the second material to form a third material. The method further includes (e) repeating steps (c) and (d) to form a composite material having n-layers of the polymer nanowire array. The number of n-layers is at least 2 (n is at least 2). The method further includes (f) reducing the deposited layers of graphene oxide to graphene sheets to form a stacked polymer nanowire array/graphene material. The stacked polymer nanowire arrays are interconnected with the graphene.

Implementations of the invention can include one or more of the following features:

Each of the layers of the polymer nanowire arrays can include polyaniline.

The number of n-layers can be at least 3 (n can be at least 3).

The step of depositing the n layer of the polymer nanowire array can in-situ reduce the n−1 layer of the graphene oxide.

The method can further include incorporating the stacked polymer nanowire arrays/graphene material in a device with an electrolyte.

The device can be used as a supercapacitor.

The supercapacitor can simultaneously have (a) an energy density at least 75 Wh/Kg and (b) a power density of at least 1500 W/Kg.

The method can further include immersing the stacked polymer nanowire array/graphene material in a liquid electrolyte. The method can further include removing the stacked polymer nanowire array/graphene material from the liquid electrolyte to form a hybrid material. The hybrid material can include the stacked polymer nanowire array/graphene material and a solid electrolyte.

The solid electrolyte can include polyvinyl alcohol.

The liquid electrolyte can include polyvinyl alcohol, H₃PO₄, and Nafion.

The method can further include drying the stacked polymer nanowire array/graphene material after the step of removing the stacked polymer nanowire array/graphene material from the liquid electrolyte.

Each of the polymer nanowire arrays can include polymer nanowires having diameters between 13.5 to 50 nm.

Each of the polymer nanowire arrays can include polymer nanowires having diameters between 40 to 50 nm.

### DESCRIPTION OF DRAWINGS

FIG. 1 illustrates a scheme of a bottom-up fabricating hierarchical nanostructure.

FIGS. 2A-2B are Scanning Electron Microscope (SEM) images of PANI nanowire array grown stepwise in HClO₄ and HCl. FIG. 2A is a top view. FIG. 2B is a side view.

FIG. 3A is an SEM image of a monolayer graphene-assembled on the top of a PANI nanowire array. FIG. 3B is a magnified view of box 301 shown in the SEM of FIG. 3A.

FIG. 4A is an Atomic Force Microscope (AFM) image of a monolayer graphene-assembled on the top of a PANI nanowire array. FIGS. 4B and 4C are graphs reflecting the thickness of the monolayer shown in FIG. 4A at lines 401 and 402, respectively.

FIG. 5A is an SEM images of a two-stack hierarchical nanostructure.

FIG. 5B is an SEM images of a three-stacked hierarchical nanostructure.

FIG. 6A is a graph of the results of a cyclic voltammetry scanning of multi-layered nanostructures scanned at 50 mV/s in an aqueous electrolyte (with curves 601-603 for one layer, two layers, and three layers, respectively).

FIG. 6B is a graph of the results of a cyclic voltammetry scanning of multi-layered nanostructures scanned at 50 mV/s in an organic electrolyte (with curves 604-606 for one layer, two layers, and three layers, respectively).

FIG. 7A is a graph of charge and discharge tests in an aqueous electrolyte (with curves 701-703 for one layer, two layers, and three layers, respectively).

FIG. 7B is a graph of charge and discharge tests in an organic electrolyte (with curves 704-706 for one layer, two layers, and three layers, respectively).

FIG. 8A is a graph of energy and power density of hierarchical samples in an aqueous electrolyte (with curves 801-803 for one layer, two layers, and three layers, respectively).

FIG. 8B is a graph of energy and power density of hierarchical samples in an organic electrolyte (with curves 801-803 for one layer, two layers, and three layers, respectively).

FIG. 9A is a graph of impedance of a hierarchical structured electrode in an aqueous electrolyte (with data points 901-903 for one layer, two layers, and three layers, respectively).

FIG. 9B is a graph of impedance of a hierarchical structured electrode in an organic electrolyte (with data points 904-906 for one layer, two layers, and three layers, respectively).

FIG. 10 is a graph of cycling performances of 3-stacked sample tested at 5 A/g in aqueous and organic electrolytes. (with curves 1001-1002 for the aqueous and organic electrolytes, respectively).

FIGS. 11A-11C are SEM images showing the structure of PANI nanowire arrays. FIG. 11A is a top view of the stepwise fabricated single layer PANI array. FIG. 11B is an unsuccessful deposition of a second layer without GO deposition (shown for comparison purposes). FIG. 11C is a top view of 2-layered sandwich-structured electrode obtained by GO assisted deposition.

FIG. 12 is an illustration of fabricating multiphase composites as solid-state supercapacitors. The graphene/PANI hybrid nanostructures were impregnated with PVA and assembled together to form ordered symmetrical solid-state supercapacitors.

FIG. 13A is a graph showing the results of a cyclic voltammetry analysis of sandwich structured electrode at various scan rates (with curves 1301-1305 for 5, 10, 50, 100, and 500 mV/s, respectively).

FIG. 13B is a graph showing the measured peak current at different scan rates with (with curves 1306-1308 for 5, 10, and 50 mV/s, respectively).

FIG. 14A is a graph showing charge-discharge performed at various current densities (with curves 1401-1405 for 0.25, 0.5, 1, 2.5, and 5, respectively).

FIG. 14B is a graph showing energy and power density dependence of sandwich structured electrodes

FIG. 15A is a graph of Nyquist plots of the sandwich structured electrodes with solid state electrolyte. Inset 1501 showed performance in an specific high frequency area.

FIG. 15B is a graph of the capacitance-frequency dependence of the cell calculated by assuming a simple RC serial model.

FIG. 15C is a graph of cycling performance of the as prepared solid-state supercapacitor carried out at 1 A/g.

### DETAILED DESCRIPTION

The present invention relates to periodic nanostructures for high energy-density and high-power density device and systems and uses thereof. Hierarchical nanostructured materials having stacked polymer nanowires forests interconnected by monolayer graphene sheets were fabricated through bottom-up nanofabrication. Driven by external voltage, aniline molecules and graphene oxide were alternatively assembled for hierarchical porous stacked nanostructures while graphene oxide was in-situ reduced to graphene during the assembly process. Scanning electron microscopy and atomic force microscope results indicated that monolayer graphene sheets served as the transition nodes for the neighboring nanowire arrays. As-produced hierarchical nanostructures were used as supercapacitor electrodes, and stack-dependent device properties were discovered. In the organic electrolyte, specific energy density was increased and power density was maintained as the stack of forests increased at each scan rate. The specific energy density of as-produced supercapacitors was as high as 137 Wh/Kg while the power density was 1980 W/Kg. The specific energy density typically had an energy density above 75 Wh/Kg while simultaneously having a power density above 2000 W/Kg. Generally, the ranges of energy density was 75 Wh/Kg to 150 Wh/Kg (or more) while the range of power density was 1500 Wh/Kg to 65,000 W/Kg (or more).

Embodiments of the present invention have distinctive energy-storage behavior that originated from the electrode/electrolyte interactions and the dependence on the diffusion and charge transferring process. The present invention provides a simple pathway to tailor electrode architecture for supercapacitors with both high energy density and high power density.

The present invention provides a highly ordered multi-layer PANI nanowires arrays interconnected by monolayer graphene are success-fully fabricated via layer-by-layer growth. Growing PANI nanowire in HClO₄ and HCl stepwise could achieve both good alignment and capability to assemble monolayer graphene. As-produced stacked forests-linked with graphene can be used as the electrode of supercapacitors, and the highest specific capacitance in aqueous electrolyte was measured as 1443 F/g. In some embodiments of the present invention, the specific capacitance in aqueous electrolyte was in the range between 1000 F/g and 1500 F/g. Also, high energy and power density can be achieved simultaneously, for instance, specifically, 100 Wh/Kg at 63,534 W/Kg.

Importantly, stack-dependent supercapacitor performance was observed in organic electrolyte. The specific capacitance increased from 79 to 108 and finally 224 F/g as the number of arrays increased from one to two and three, respectively. In some embodiments of the present invention, the specific capacitance in organic electrolyte was in the range between 75 F/g and 250 F/g. Also, a high energy density was achieved as 137.3 Wh/Kg when the power density was 1980 W/Kg for the three-stacked nanostructured electrode. It is believed that the unusual layer-dependent energy-storage behavior was caused by different diffusion and charge transferring mechanisms due to the distinct interactions between electrode and electrolyte. Because of the efficient spacious utilization of multiple layered structures, this novel nanostructured electrode provides numerous embodiments of exceptional ultra-capacitors having a reduced lateral size.

Accordingly, the present invention provides both high energy density and high power density. The present invention further provides a method whereby tailoring the number of nanowire arrays can increase the energy density while retaining the power density.

This technology can be used in various storage devices, including, for example, plug-in electric vehicles, hybrid electric vehicles, power tools, unmanned aerial vehicles (UAV), and communication devices (such as cell phones, mobile devices, etc.).

Furthermore, highly aligned PANI nanowire arrays interlinked by a thin layer GO was fabricated by in-situ electrochemical polymerization and deposition, and then incorporated into PVA for producing novel multiphase composites, which also serve as solid-state supercapacitors. The specific capacitance was measured to 83 F/g at 0.1 A/g and it showed very less dependence on the current density. The hybrid composites also showed superior stability on the energy density in a big range of power density. When power density ranged from 70 W/kg to 3600 W/kg, the energy density remained at 26.5 Wh/kg. As-produced solid state supercapacitors also demonstrated stable capacitance on both low frequency and high frequency, which may be due to the improved charge transporting of the solid state electrolyte. The specific capacitance became quite stable after the 13% drop in the first 400 cycles. These results indicated both delicate PANI nanostructure and excellent charge transportation of the electrolyte play a critical role in the high performance solid-state supercapacitors.

### Preparation of the Stacked PANI Array/Graphene Nanostructures

Materials

Natural graphite flake, 45 μm (grade 230), was provided by Asbury Carbons (Asbury, N.J.). Fuming nitric acid and aniline (ANI) were purchased from Alfa Aesar. Sodium chlorate, hydrochloric acid, and perchloric acid were obtained from Aldrich (ACS reagent), and were used as received.

Preparation of the 1st Layer of PANI Nanowire Array

A platinum (1×1 cm²) sheet was washed in hot sulfuric acid, DI water, and ethanol, and then it was mounted as the positive electrode on Keithley 2400, and a platinum wire was employed as the negative electrode. The electrode couple was immersed into 0.1 M ANI aqueous solution which contained 1 M HClO₄ as the dopant. The reaction was carried out at 0.75 V, and the current was adjusted to approximately 2 μA/cm². After the electrode dwelled for 6 hours, it was transferred into a solution containing 1 M HCl and 0.1 M ANI; all other parameters were kept the same, and the reaction lasted for 1 hour.

Preparation of the Graphene Oxide

Graphite oxide (GO) was prepared by a modified Brodie's method [Brodie 1859], and followed by 10 times of DI water wash. Then ultrasonic was applied for 10 hours for the exfoliation. Finally, the exfoliated GO was centrifuged under 12000 rpm for 0.5 hours, and the top clear solution was collected.

Assembly of the 1st Layer of GO

In order to obtain a continuous GO coating, electrodes were transferred into GO aqueous solution. 10 μL, 37% HCl was added to increase the conductivity. The voltage was raised to 1.2 V and the reaction was carried out for 5 min. After deposition, the PANI/GO electrode was immersed into DI water for 5 min to wash the physically attached GO.

Fabrication of Multi-Stacked Polymer Forest

The second layer of PANI was fabricated by following the steps in “Preparation of the 1st layer of PANI nanowire array” set forth above, but using as-prepared PANI/GO as a positive electrode, resulting in PANI/GO/PANI forest. Subsequently, the 2nd layer of GO was assembled on the PANI/GO/PANI forest by following the steps in “Assembly of the 1st layer of GO” set forth above, but PANI/GO/PANI was used as the electrode, resulting in PANI/GO/PANI/GO forest. Finally, the 3rd layer of PANI nanowire array was grown by following the method and procedure in “Preparation of the 1st layer of PANI nanowire array” set forth above, and using PANI/GO/PANI/GO material as a positive electrode. As a result, a multi-stack ordered structure was achieved.

Characterization

The morphology of the resulting PANI nanowires array was examined by Hitachi S4300 scanning electron microscopy. AFM was scanned on XE-100 (Park Systems Inc.) in contact mode using a silicon cantilever (Nanoscience Instruments, Inc.) with a nominal spring constant of ˜1 N/m and tip diameter of around 10 nm. All AFM imaging was performed at a scan rate of 0.5 Hz using a cantilever with a driving frequency of 325 kHz (256×256 lines scan).

Electrochemical properties were studied by using as prepared multi-layered PANI nanowires array as the working electrode, a Pt wire as the counter electrode, and Ag/AgCl as the reference electrode in 0.5 M H2SO4 aqueous solution and 0.1 M tetrabutylammoniumhexa-fluorophosphate (TBAPF₆) in acetonitrile. Cyclic Voltammetry (CV) and chronopotentiometry tests were performed on an electrochemical working station (CHI 660D, CH Instrument Inc.) to calculate the specific capacitance, and electrochemical impedance was employed to study dynamic performance of the electrodes.

Results

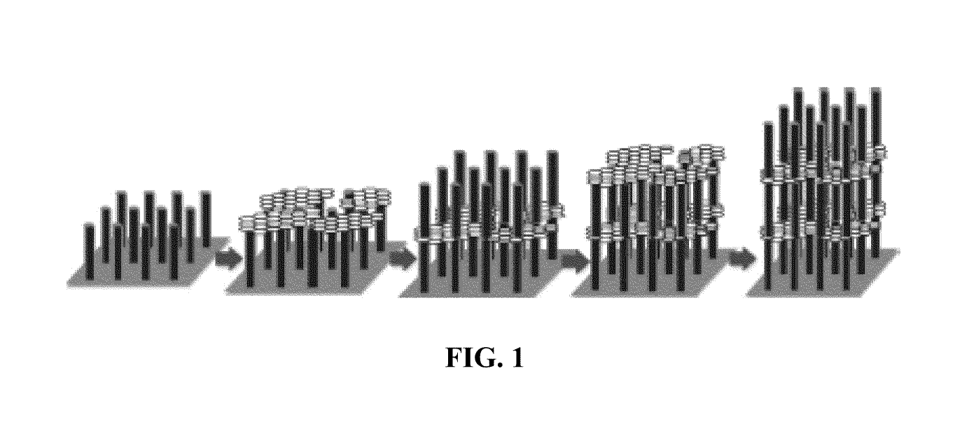

Vertically aligned polyaniline (PANI) nanowires were synthesized by the electrochemical method with controlled diameter and length [Wang 2010; Liu 2003]. In addition, after the electrochemical deposition GO could be in-situ reduced during further PANI growing [Sheng 2012; Miller 2010]. The alternative growth of PANI nanowire array and assembly of monolayer GO were carried out for hierarchical nanostructures, and the schematic illustration is shown in FIG. 1.

Low current density and dilute concentration can create a particle-like nucleation and subsequent vertically aligned nanowires instead of a solid film [Liu 2003]. Thus PANI nanowire arrays were synthesized by the electrochemical method at 2 μA/cm² with HClO₄ and HCl as dopants. PANI nanowires doped by HClO₄ showed better alignment than those doped by HCl, as proved in Applicant's previous work [Li 2013], and their diameters are at around 20-30 nm.

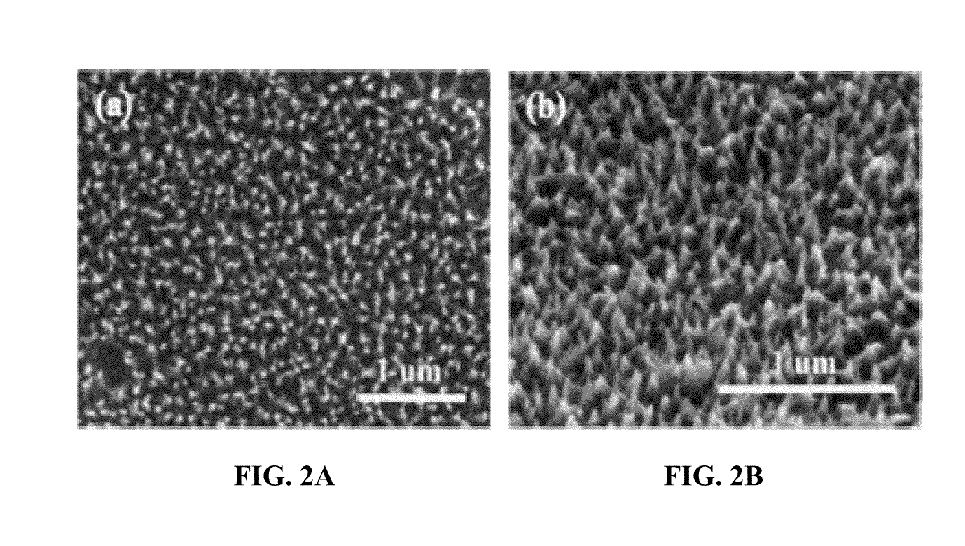

For the PANI nanowires doped by HCl, monolayer GO can easily assemble onto them. However, GO could not be assembled onto the HClO₄ doped PANI nanowire. Since PANI nanowires grown in HCl show a poor alignment, a combined method was developed to produce well-aligned PANI nanowire array for ready assembly of monolayer GO. Specifically, the synthesis is carried out in the 1 M HClO₄ for 6 hours, and then in 1 M HCl for another 1 hour. The top view and side view of the stepwise grown PANI nanowires array are shown in FIGS. 2A-2B, respectively. All the nanowires are vertically aligned and the diameter distribution is uniform.

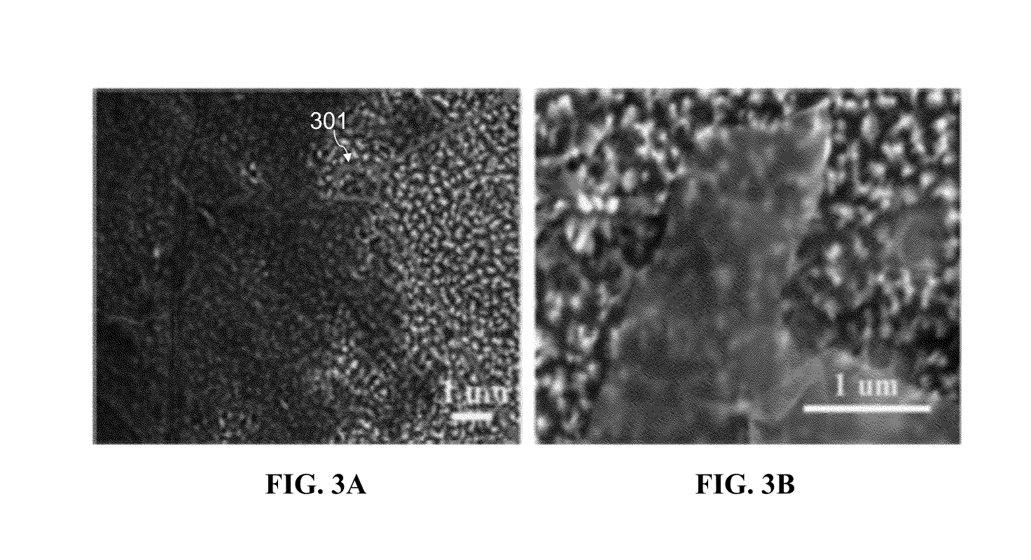

Monolayer GO sheets were then assembled onto the nanowire array by the electrochemical method. The morphology of GO coating is shown in FIGS. 3A-3B. A high-coverage and continuous coating of GO was obtained. (For better comparison, Applicant intentionally coated half of PANI array and showed the edge of the coating in SEM characterization). In addition, the orientation of PANI nanowires was almost unaffected since the GO layer was ultra-thin. The GO-assembled array was intentionally washed for 15 min in deionized water, and GO still stayed on the PANI array, indicating strong bonding between GO and PANI.

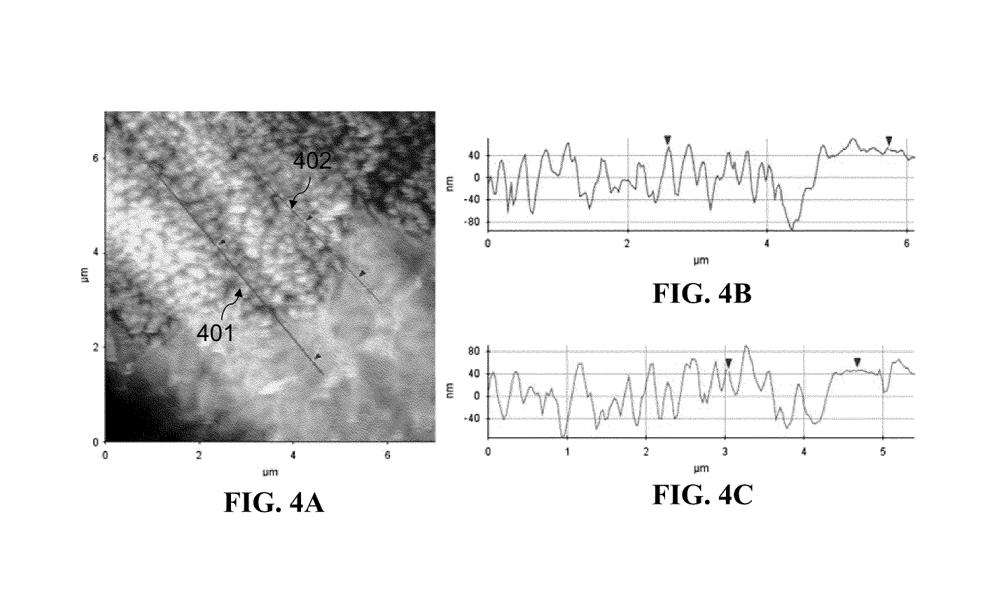

The thickness of the as-assembled GO film was studied by AFM. The image is shown in FIG. 4A. On the un-coated area, the top of nanowires was observed, showing ordered uniform dots. For those coated by GO, a much flatter surface was observed. Cross-section analysis was carried out (see FIGS. 4B-4B) and the height difference between the coated and un-coated area was around 0.88 nm on average. Due to the rough topology of the nanowire array and the interactions between AFM probe and PANI, it was safely confirmed that monolayer graphene was assembling on the top of PANI nanowire array.

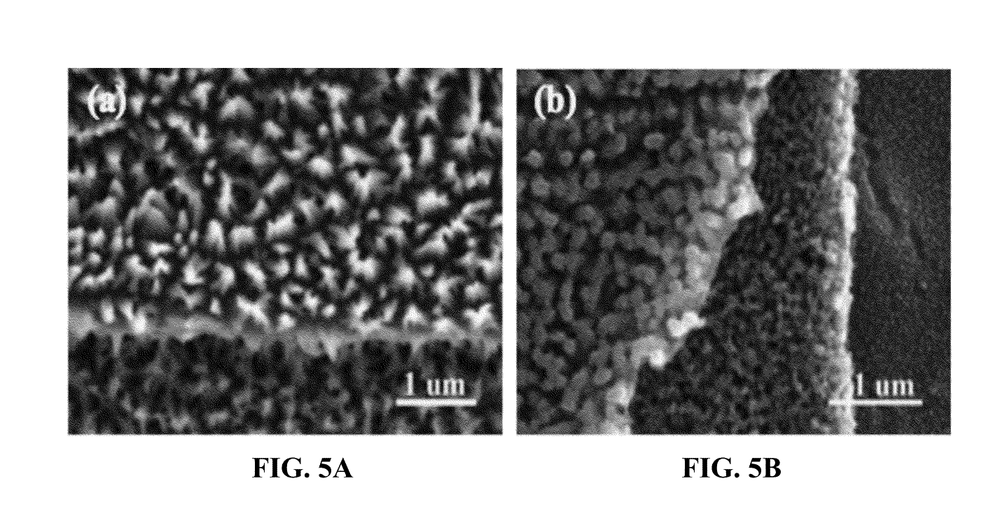

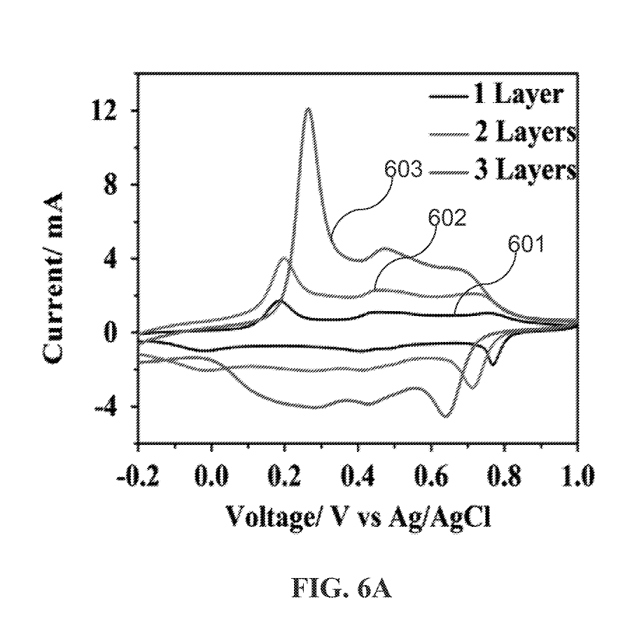

Alternative growth of PANI nanowire arrays and assembly of monolayer graphene resulted in hierarchical porous nanostructures monolayer graphene-linked multi-stacked nanofiber forests. As-produced samples were broken after immersing them into liquid nitrogen for 5 min. The cross-section was characterized by SEM, as shown in FIGS. 5A-5B.

In the two-stacked PANI nanowires arrays, the alignment and the diameter distribution of nanowires in each stack are almost the same. The effective bonding between PANI nanowires array and GO strongly supported the further assembly of the second and the third layers. However, the diameter of nanowires in the third layer appeared to be larger than that in the second stack while nanowires in the bottom stack showed the finest size. Applicant believes that this may stem from current gradient during the assembly driven by external voltage and the details are still under study.

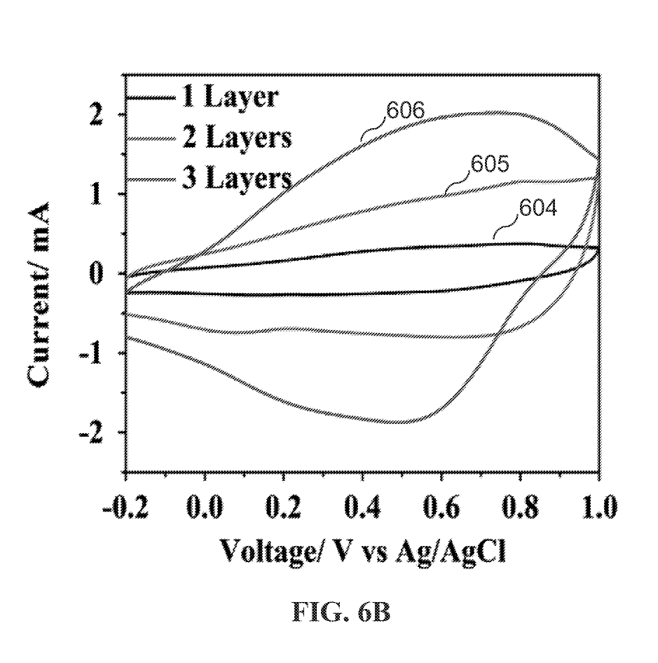

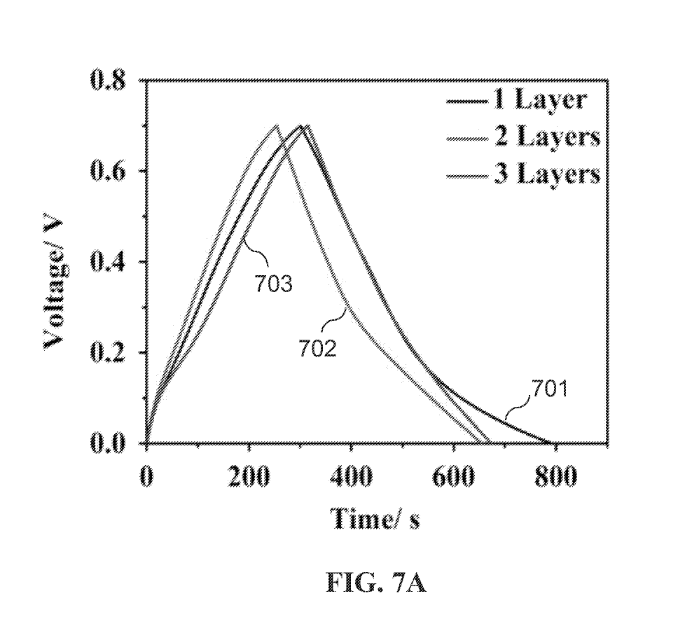

Stacked polymer forest-linked with graphene was used as the electrode of the supercapacitor, and its electrochemical performance was studied in aqueous (0.5 M H2SO₄ aqueous solution) and organic solutions (0.1 M tetrabutylammonium hexafluorophosphate in acetonitrile). The electrochemical behaviors were investigated as the function of layers in the multi-stacked hierarchical nanostructures and the results are shown in FIGS. 6A-6B. For the cyclic voltammetry scanning, obvious oxidation and reduction were observed in aqueous electrolyte, indicating pseudo-capacitive behavior. On the other hand, no obvious oxidation and reduction peaks were observed in the organic electrolyte, implying an electric double-layer capacitive behavior. The polarizing current increased linearly with the number of layers of the arrays. Specifically, the peak value of polarizing current for the supercapacitor using one-layer PANI as electrode in aqueous electrolyte was around 0.4 mA at a scan rate of 0.8 V. It increased to 0.8 mA when a two-layered forest was used as an electrode. It reached 2 mA when a three-layered forest was used as an electrode. In addition, the same trend was found in the supercapacitors using organic electrolyte.

In addition, the charge-discharge tests were also carried out as a function of layer numbers of multi-stacked hierarchical nanostructure. The specific capacitance is calculated by the equation:

Cₛ=I×t/m×ΔV.

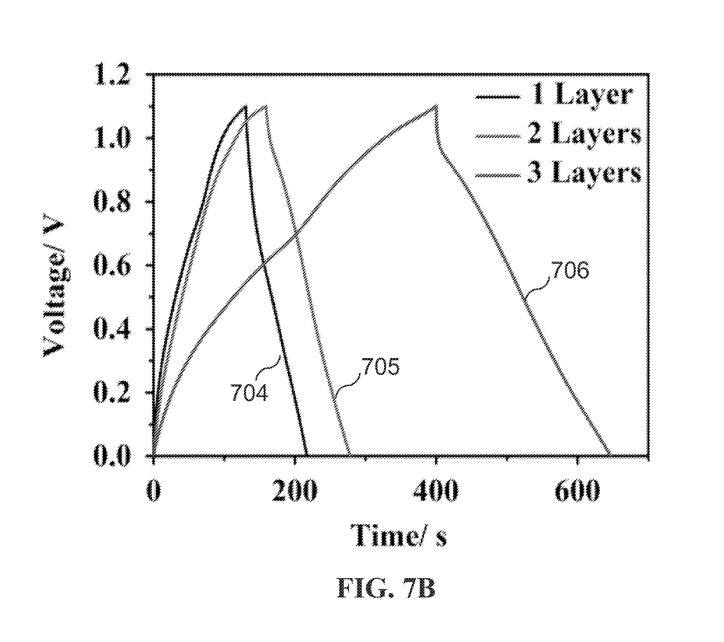

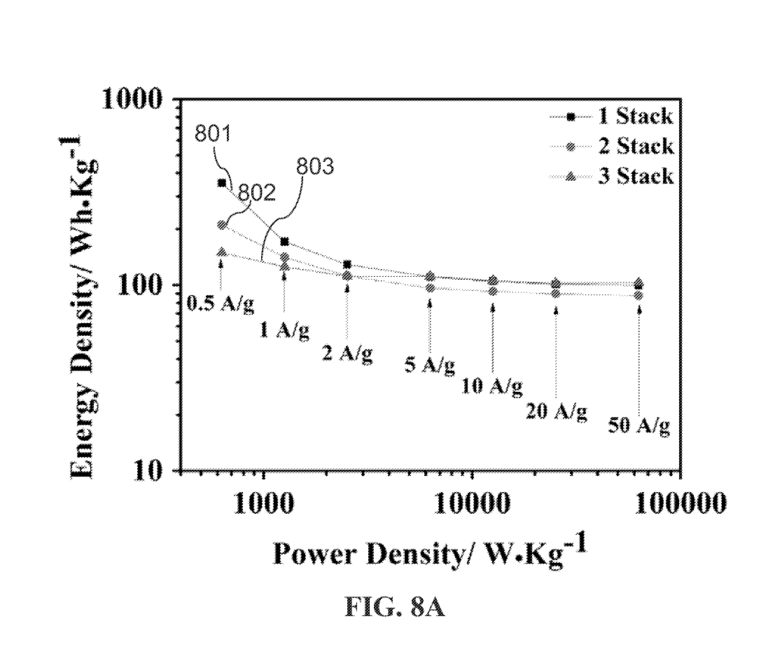

In the aqueous solution, the highest specific capacitance was measured as 698 F/g under 1 A/g current density in one-stack PANI nanowire array. As the stacks increased, the specific capacitance dropped quickly to 511 F/g in the three-stacked sample at 1 A/g, resulting in 26.7% decrement. The layer-dependent charge-discharge is shown in FIG. 7A. However, the specific capacitance of the three-stacked sample decreased much slowly at the higher discharge current densities, and the details are shown in Table 1, below.

TABLE 1
Specific Capacitance (F/g) of supercapacitors
using various electrodes at scan rates

| | | | | | | | |
|---|---|---|---|---|---|---|---|
| Scan rate | 0.5 A/g | 1 A/g | 2 A/g | 5 A/g | 10 A/g | 20 A/g | 50 A/g |

Aqueous electrolyte

| | | | | | | | |
|---|---|---|---|---|---|---|---|
| 1-layer forest | 1443 | 698 | 525 | 451 | 427 | 411 | 406 |
| 2-layer forest | 857 | 574 | 456 | 392 | 376 | 366 | 357 |
| 3-layer forest | 609 | 511 | 454 | 453 | 430 | 416 | 420 |

Organic electrolyte

| | | | | | | | |
|---|---|---|---|---|---|---|---|
| 1-layer forest | 91 | 78 | 73 | 68 | 66 | 61 | 50 |
| 2-layer forest | 113 | 107 | 109 | 108 | 109 | 103 | 90 |
| 3-layer forest | 225 | 224 | 214 | 204 | 193 | 183 | 163 |

For example, the specific capacitance only decreased by 17.8% at 50 A/g. By switching the electrolyte from aqueous solution to organic solution, an interesting phenomenon was observed. The specific capacitances in the organic electrolyte increased as a function of the number of layers, completely opposite to the trends in the aqueous electrolyte. The curves are presented in FIG. 7B. The specific capacitances are 79, 108 and 224 F/g at 1 A/g for one-, two- and three-layered hierarchical nanostructures, respectively.

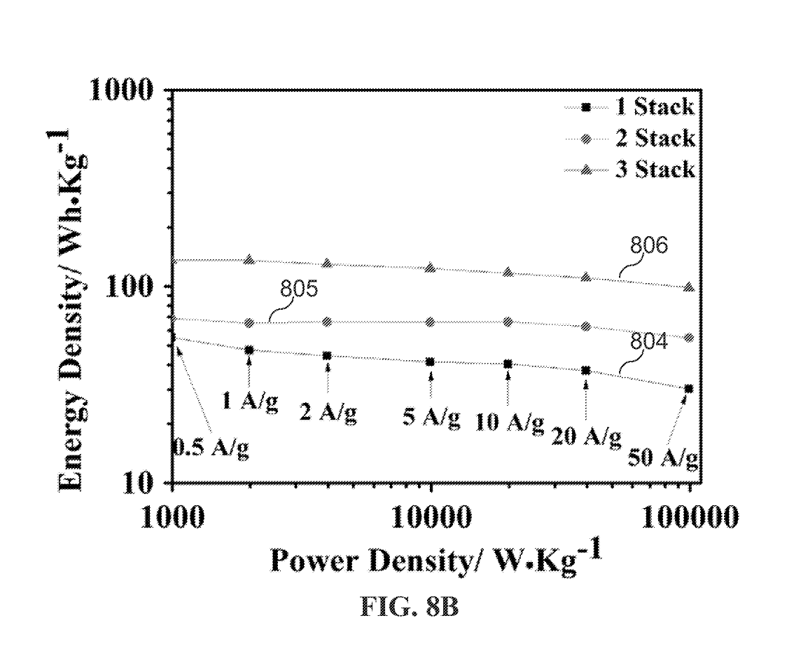

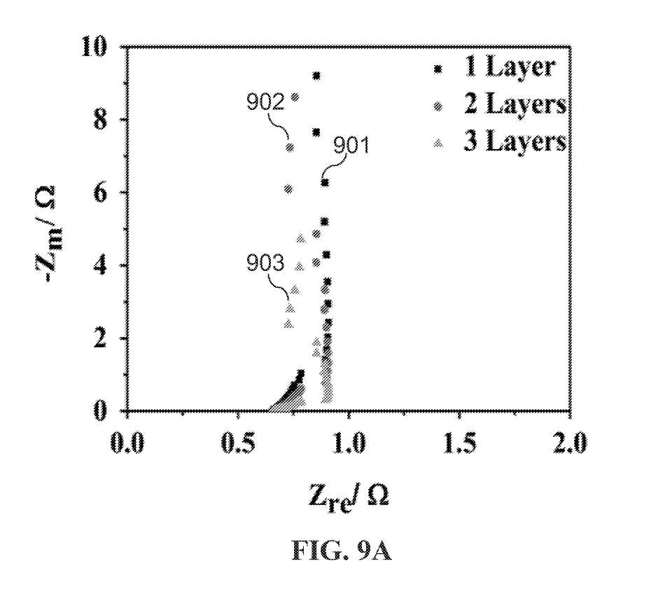

The energy and power density were calculated by employing the equation E=½CV² and the data in Table 1. The results are plotted in FIGS. 8A-8B.

In the aqueous electrolyte, although the cell was only charged to 0.7 V (FIG. 7A), the intrinsic high specific capacitance of the delicately structured PANI still led to an initial energy density to as high as 350 Wh Kg⁻¹ for 1-stack electrode. However, it decreased quickly to around 100 Wh Kg⁻¹ while the power density was increased. When the energy-density was around 100 Wh Kg⁻¹, no obvious further decrement was observed even though the power density was significantly increased for a specific sample.

In the organic electrolyte, although the specific capacitances were much lower, the energy density was very high because of increasing the operation voltage till 1.1 V. The energy density of supercapacitors increased and power density stayed the same as the number of the stack increased at each scan rate. For example, at the charge-discharge current of 1 A/g, the energy density of 1-stack, 2-stack and 3-stack forest-based supercapacitors was 47, 65, and 137 Wh Kg⁻¹, respectively. On the other hand, the power density for these supercapacitors still remained 1980 W Kg-1. Therefore, this significantly enhanced the energy density at a high power density. This suggests an innovative method to fabricate high specific energy density and power density ultra-capacitors.

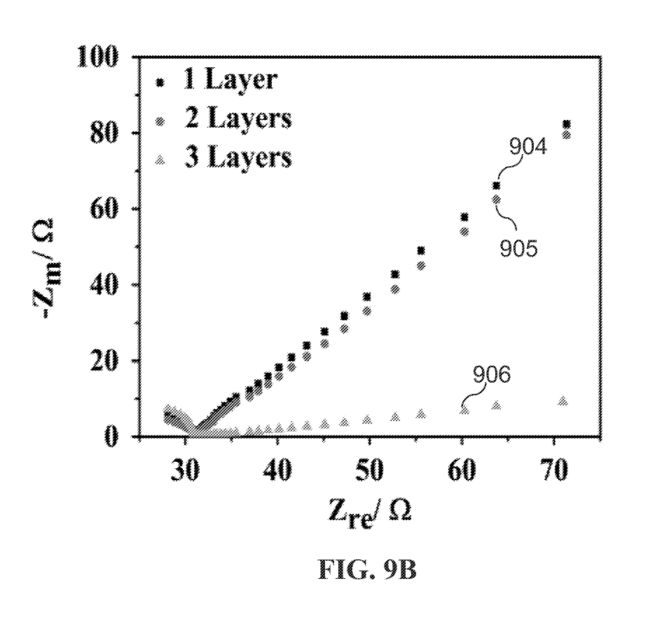

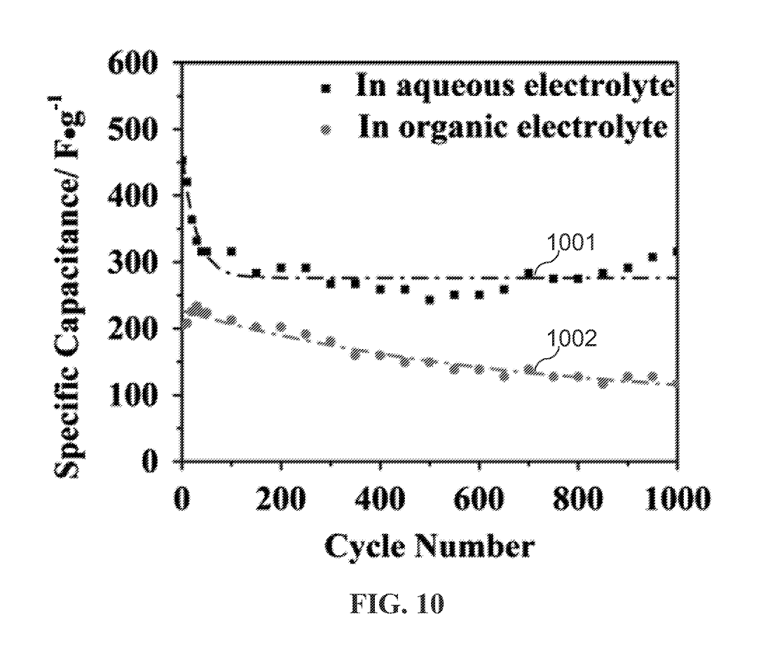

The unique layer-dependent electrochemical performance was further investigated by impedance tests, as shown in FIGS. 9A-9B. In the aqueous solutions, the equivalent series resistance (ESR) was less than 1.0Ω and the shape of the curve clearly indicated finite-length porous electrodes. Proton (H₊) in acid solution could significantly dope PANI and make PANI highly conductive. Thus the charge transfer happened very quickly and electrochemical behavior was primarily dependent on the diffusion process. The diffusion resistance was approximately calculated as 0.75Ω by using the equation:

R_{Σ}=3(Rᵢ−ESR)

where R_{Σ} is the diffusion resistance and Rᵢ is the intersection between high and low frequency.

With the increasing number of PANI arrays, the diffusion will be more difficult because the vertical diffusion path was blocked by graphene, and thus the specific capacitance decreases slightly. On the other hand, there is no proton doping in the organic electrolyte and PANI is less conductive. Thus charge-transfer process dominates the whole electrochemical process. As shown in FIG. 9B, the equivalent series resistance was as high as 28.1Ω, indicating higher resistance of the system. As GO was assembled and in-situ reduced, the band gap of hierarchical nanostructured materials was lowered, and charge carriers density was increased. With more graphene layers introduced into the hierarchical nanostructures, charge-transfer capability was improved. The charge transfer resistance was calculated as 2 Ω, 1.7Ω, and 0.26Ω for one-, two- and three-layer nanostructured electrodes, respectively, derived from the slope of low frequency region. This also agrees well with R. Wang 2012.

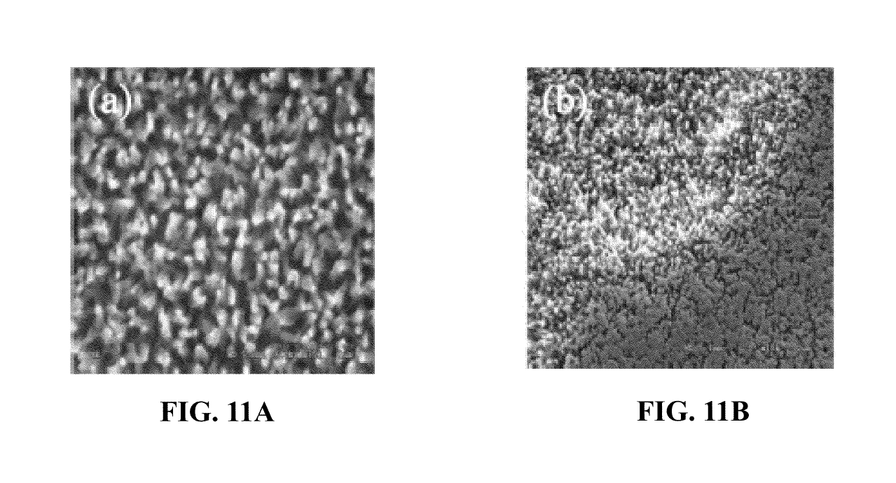

The cycling performances of the supercapacitors using stacked polymer forests were examined in both aqueous and organic electrolytes. The results are shown in FIG. 10. The experimental results were also fitted by dotted lines, and the decrement of specific capacitance seems to follow an exponential distribution.

In the aqueous system, specific capacitance decreased significantly in the first 100 cycles, decreasing from 453 F/g to 289 F/g. However, in the following 900 cycles, the decreasing rate was much slower.

On the other hand, when the aqueous electrolyte was replaced by an organic electrolyte, the specific capacitance dropped steadily. The cyclic performance can be approximately split into two phases. In the first 500 cycles, the capacitance dropped by 32%, and in the rest of cycles only by 8%.

In order to obtain an insightful understanding of the relation between structure, electrolyte and electrochemical performances, the electrochemical behavior was further investigated. In the aqueous system, diffusion is the dominating process since the electrochemical process is dominated by the slowest step. Their electrochemical behavior can be described by the following equations [Bard 2000]:

iₚ=an^{1.5}AD^{0.5}Cυ^{0.5}

i=iₚ(nF/RT)(E−E_{eq})

Cₛ=it/(Δυm)

where iₚ stands for the peak current; a is a constant, 2.69×10⁵; n is the number of electrons transferred; A is the surface area of the electrode; D is the diffusion coefficient of electrolyte; υ is the scan rate; C is the bulk concentration of electrolyte; i is the electrode current; F is the Faraday constant; R is the gas constant; T is the thermodynamic temperature; E is the electrode potential; E_{eq} is the equilibrium potential; Cₛ is the specific capacitance; t is the scanning time; Δυ is the voltage difference between the beginning and ending of the scan; and m is the mass of the PANI on the electrode.

Combining them together results in a new equation as follows:

Cₛ=an^{2.5}AD^{0.5}Cυ^{0.5}F(E−E_{eq})/(RTΔυm)

The specific capacitance is a function of sophisticated competition among number of electrons transferred, electrode surface area and electrode mass. Since PANI is in the highest doping state in aqueous solution, the number of transferred electrons versus mass would not further increase in multiple layered electrodes. In fact, it decreases because of the forming of big nanowires.

The specific electrode surface area is deteriorated as well. As a result, the specific capacitance was decreased due to more stacked nanowire arrays. On the other hand, in an organic system, the original H⁺ doping state of electrode is low and the charge transfer is the dominating step. The GO coating plays a big role in charge transferring after its deposition and in-situ reduction. Reduced GO sheets interconnected neighboring polyaniline nanowire arrays, and could also tune carrier density in the electrode. Thus more transferred electrons could be expected as the number of layers of hierarchical nanostructures was increased. Therefore, the electrode behaves entirely different in the organic electrolyte system.

### Preparation of Ordered Multiphase Polymer Nanocomposites for High-Performance Solid-State Supercapacitors

Materials

Natural graphite powder, size of 45 μm (grade 230), was obtained from Asbury Carbons (Asbury, N.J.). Fuming nitric acid was provided by Alfa Aesar Inc. and used as received. Sodium chlorite, Nafion, PVA, and aniline (ANI) were purchased from Sigma Aldrich (ACS reagent), and used as received. Hydrochloride acid (37%) and perchloric acid (70%) were provided by Macron Chemicals. (Nafion is a sulfonated tetrafluoroethylene based fluoropolymer-copolymer and belongs to a wide class of solid superacid catalysts).

Preparation of Graphene Oxide Solution

Graphite oxide was prepared by mixing 10 g graphite, 160 mL fuming nitric acid, and 85 g sodium chlorite at room temperature, and then stirred for 24 hours. 5 mg of the resulted graphite oxide was dispersed into 150 mL DI water subjected 8 hour sonic processing. Finally, the graphite oxide was exfoliated by sonic processing and further centrifugation at 12,000 rpm for 30 min help to achieve graphene oxide (GO).

Preparation of PANI/Graphene Composites and Solid-State Supercapacitors

A 1×1 cm platinum plate was polished and washed with 1 M HCl and DI water in the sonication bath, respectively. Then, the platinum was mounted as anode and a platinum wire was employed as a cathode. The electrochemical deposition was carried out in the 0.1 M ANI and 1 M HClO₄ aqueous solution for 6 hours, and subsequently in the 0.1 M ANI and 1 M HCl aqueous solution for 1 hour. The deposition voltage was set at 0.75 V and the current was maintained at 2 μA/cm² by adjusting the depth of the cathode. Next, GO was deposited by immersing the electrodes into the previous prepared-GO aqueous solution with 1.2 V between two electrodes. HCl was added and the concentration was adjusted to 1 M. The electrodes were dwelled for 5 min. Finally, the second PANI nanowire array was produced on the graphene layer by following the second step exactly, resulting in graphene-linked multi-stacked nanowire arrays.

The electrolyte was prepared by dissolving 3 g H₃PO₄ and 3 g PVA into 60 mL DI water. The solution was filtered by the membrane with 0.2 μm pores. Subsequently, additional Nafion was added into the electrolyte where Nafion amount is half of the H₃PO₄ weight. The solid-state supercapacitors were prepared by immersing the as-prepared electrodes into the mixed electrolyte for 3 hours to ensure the full wetting of electrolyte on electrode. The resultant hybrids were then taken out of the electrolyte and a small amount of electrolyte was casted on the electrodes. The electrodes were dried on the hot plate at 50° C. and two electrodes were pressed at 1 ψ for 10 min to create solid-state supercapacitors. The structure and morphology of the PANI nanowire arrays were characterized by scanning electron microscopy (SEM, Hitachi S4300). Electrochemical performance was investigated by using a CHI 660D electrochemical workstation in a two electrodes configuration.

Results

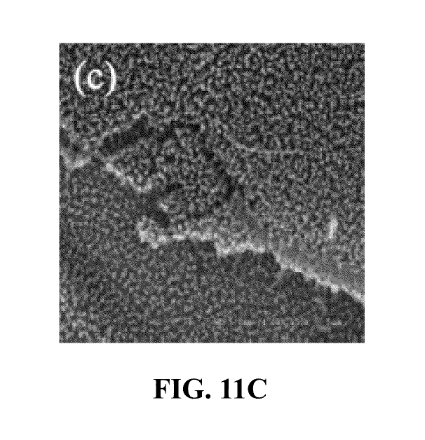

As found in the previous research, the electrode structure significantly influences the dynamic electrochemical performances [Wang 2010; Xue 2012; Kuila 2009]. As-produced graphene/PANI hybrid structure could significantly tune the electrochemical properties. The structure of as-produced PANI/Graphene/PANI electrodes is shown in FIGS. 11A & 11C. Small current can help to achieve the high aspect ratio of PANI nanofibers [Wang 2010; Liu 2003]. Therefore, 2 μA/cm² was employed. With the increasing oxidation capability of the acidic dopant, higher ratio of C═N or C—N could be expected, resulting in a more rigid molecular chain and better alignment [Hatchett 1999]. As shown in FIG. 11A, PANI nanowires were obtained with small diameters as low as 40-50 nm. The variation of the nanofiber diameters was very small. Some PANI fibers clustered together due to the surface tension during the drying. In order to understand the role of the deposited GO, an electrode was fabricated by the same procedure without GO deposition, and the result of interface of 1st and 2nd is shown in FIG. 11B. When the 2nd deposition process was carried out without the GO assembled on the top of 1st nanowire array, the space between the nanofibers was filled by PANI and almost formed a continuous solid film. In contrast, for the GO-coated PANI nanowire array, the 2nd deposition process helped to produce well-defined nanowire array on the graphene layer, which is entirely different. As demonstrated in FIG. 11C, all the characteristics in 1st layer were almost the same as that in the 2nd layer, such as nanowire diameter, area density, and diameter size distribution and layer thickness.

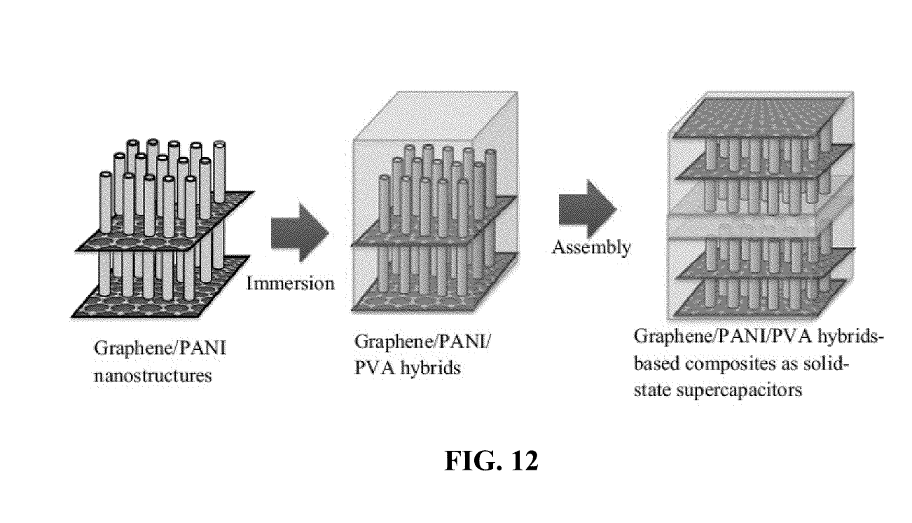

As-produced PANI/graphene hybrids were assembled in a symmetric solid-state supercapacitor as illustrated in FIG. 12. Graphene/PANI hybrid nanostructures were immersed into the aqueous H₃PO₄/Nafion-modified PVA solutions and then dried. Two sets of graphene/PANI/PVA composites were assembled together symmetrically with a thin layer of PVA coated in between of them, resulting in a solid-state supercapacitor. As a result, PANI/graphene was used as electrode while H₃PO₄/Nafion-modified PVA was used as electrolyte, and PVA served as a separation layer of the supercapacitors.

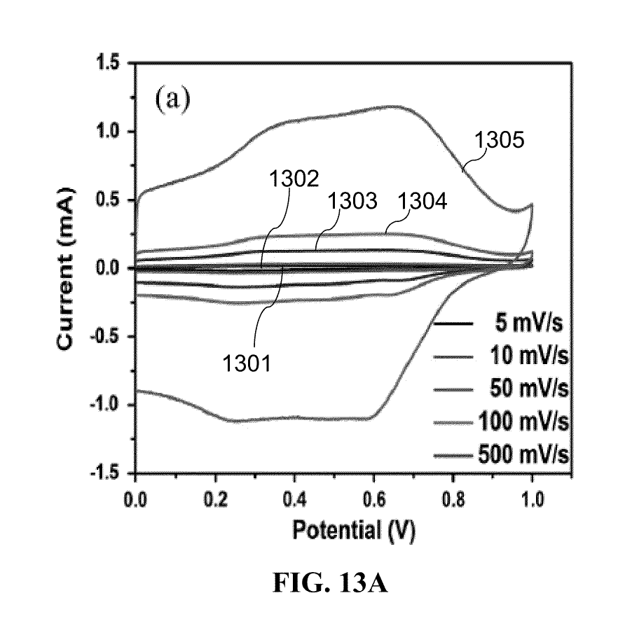

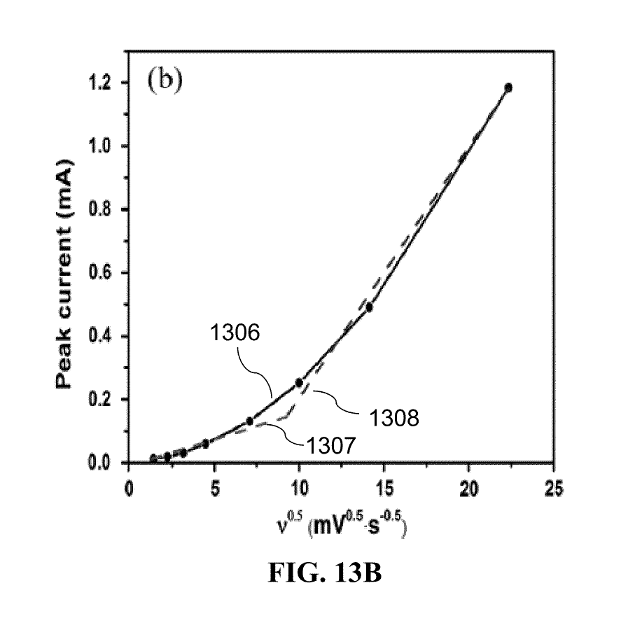

The cyclic voltammetry tests were performed for the as-produced hybrid composites, and the results are shown in FIG. 13A, indicating typical capacitive behavior. No obvious oxidation and reduction peaks were observed, and this may stem from the confinement of ion charges in the solid-state composites. In a common three electrodes system, the characteristic peaks of proton doped PANI appeared at 0.3 and 0.6 V corresponding to different oxidation states. However, the ions transportations in the solid-state electrolyte were so constrained that the peak current cannot be reached. To further understand it, the maximum current was taken as the peak current and plotted against the square root of the scan rate. For the diffusion-dependent electrochemical system, the plot of current versus root square of the scan rate followed a linear trend and the behavior can be described by the equation (as described above):

iₚ=an^{1.5}AD^{0.5}Cυ^{0.5}

According to the results shown in FIG. 13B, the curve can be approximately divided into two stages. When the square root of scan rate was higher than 10, the peak current increased much faster, indicating additional charge transfer at a higher scan rate.

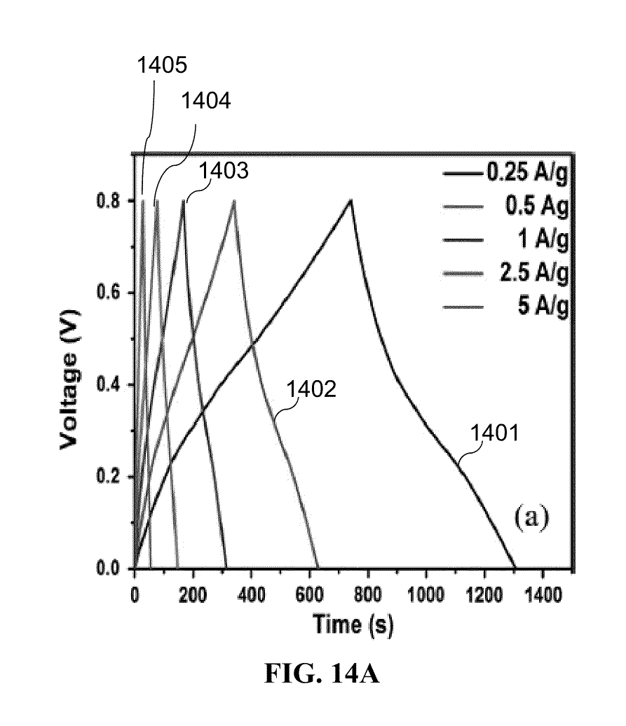

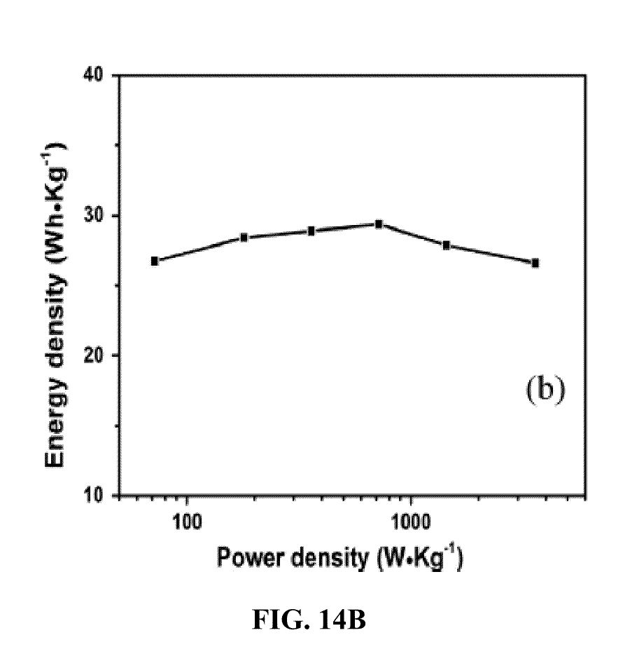

Chronopotentiometry was also carried out and the results at various current densities are presented in FIG. 14A. The specific capacitance can be calculated according to the charge or discharge slope and maximum operation current. The discharge time was almost equal to the charge time for all the curves, indicating high columbic efficiency [Yuan 2012]. The differences of slope in the charge-discharge curves implied three transformations between pernigraniline base to emeraldine salt and finally leucoemeraldine base [Li 2013]. The specific capacitances were calculated by using the equation regarding the discharging results discussed above:

Cₛ=it/(Δυm)

For the symmetric two electrodes configuration the Cₛ′=0.5Cₛ. Hence, the calculated specific capacitance (Cₛ′) were 83, 88, 90, 91, 87, and 83 F/g at 0.1, 0.25, 0.5, 1, 2.5, and 5 A/g, respectively. It was worth to note that the specific capacitance remained constant even though the current density increased 50 times. The energy density was calculated by using the equation:

E=0.5CΔυ²

and the power density was calculated by

P=E/t

The results are shown in FIG. 14B. The energy density increased slightly as the increase of the power density in the middle power density range. The energy density was 26.7 Wh/kg when the power density was 72 W/kg. It increased to 29.4 Wh/kg when the power density increased to 720 W/kg. The energy density still remained around 26.6 Wh/kg when the power density reached 3600 W/kg. This pairing of high energy density and high power density was superior to many results in the previous work [Kang 12012; Kang II 2012], indicating the greater potential of the (H₃PO₄—Nafion)/PVA solid-state electrolyte.

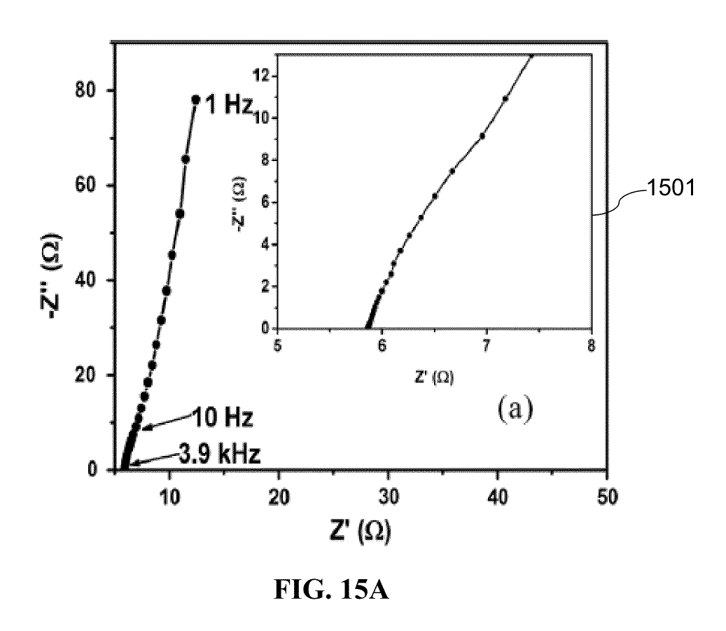

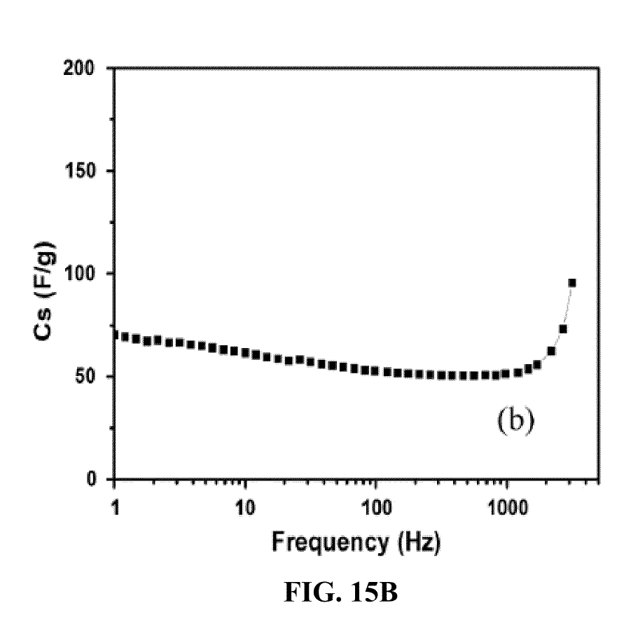

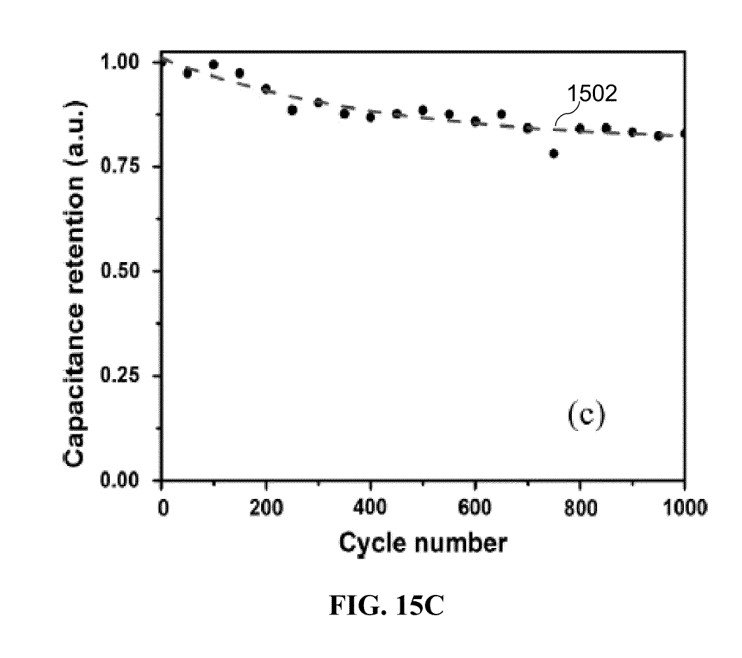

To confirm the performance of the sandwich electrode at various frequencies, the electrochemical impedance test was carried out and the result is shown in FIG. 15A as Nyquist plots. The equivalent series resistance (ESR) was 5.83Ω derived from the intersection of plots cross the x-axis. This was at the same magnitude as some aqueous and organic liquid based electrolytes. In the range of 10-1 Hz, the linear plots indicated an ideal capacitor like performance. The inset 1501 showed performance in a specific high frequency area, where the curves were still quasi linear, indicating a negligibly charge transfer resistance. The dynamic specific capacitance was calculated by using to the equation:

C=−1/(2πfZ″)

### [Du 2013].

The results were plotted in FIG. 15B. In the equation C denotes specific capacitance, f stands for frequency and Z″ is the imaginary part of the impedance.

The capacitance decreased steady from 70 F/g with the increasing of the frequency; however it still maintained 70% of original capacitance at 1000 Hz when the frequency was 1000 times. It should be denoted that only around 7% capacitance loss was found between 100 and 1000 Hz. When the frequency was higher than 1000 Hz, the capacitance increased significantly. This may be because the Z″ approached to 0 with the increasing frequency. Finally, the capacitive performance was studied and the result is shown in FIG. 15C. It seemed that the decrease of the specific capacitance followed an exponential decaying and it was fitted by the dashed line 1502. The major loss of capacitance happened in the first 400 cycles, which was around 13% decrement. This may be caused by the degradation of amorphous PANI with a small molecular weight. In the phase two the performance was much more stable and only 5% of the capacitance was discovered.

The examples provided herein are to more fully illustrate some of the embodiments of the present invention. It should be appreciated by those of skill in the art that the techniques disclosed in the examples which follow represent techniques discovered by the Applicant to function well in the practice of the invention, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

While embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, other embodiments are within the scope of the following claims. The scope of protection is not limited by the description set out above.

### RELATED PATENTS AND PUBLICATIONS

The following patents and publications relate to the present invention:
U.S. Pat. No. 8,644,000, “Nanostructured dielectric materials for high energy density multilayer ceramic capacitors,” issued Sep. 13, 2013, to Dogan et al.
U.S. Pat. No. 8,507,390, “Methods and devices for forming nanostructure monolayers and devices including such monolayers,” issued Aug. 13, 2013, to Chen et al.
U.S. Pat. No. 8,368,048, “Nanostructured layers, methods of making nanostructured layers, and application thereof,” issued Feb. 5, 2013, to LoCascio et al.
U.S. Pat. No. 8,299,761, “Dense energy storage via interacting nanostructures,” issued Oct. 30, 2012, to Pinto.
U.S. Pat. No. 8,257,788, “Nanostructured layer and fabrication methods,” issued Sep. 4, 2012, to Taghizadeh et al.
U.S. Pat. No. 8,073,299, “Fabrication of nanostructured materials,” issued Dec. 6, 2011, to Fidanza et al.
U.S. Pat. No. 6,882,051, “Nanowires, nanostructures and devices fabricated therefrom,” issued Apr. 19, 2005, to Majumdar et al.
U.S. Patent Publication No. 2013/0320582, “Interconnected hollow nanostructures containing high capacity active materials for use in rechargeable batteries,” published Dec. 5, 2013, to Cui et al.
U.S. Patent Publication No. 2013/0230736, “Nanostructure device and method for manufacturing nanostructures,” published Sep. 5, 2013, to Kabir.
U.S. Patent Publication No. 2013/0228466, “Fabrication of multilayered nanosized porous membranes and their use for making novel nanostructures,” published Sep. 5, 2013, to Sun.
U.S. Patent Publication No. 2012/0251583, “Methods of making nucleic acid nanostructures,” published Oct. 4, 2012, to Rothemund.
U.S. Patent Publication No. 2008/0157354, “Multiple stacked nanostructure arrays and methods for making the same,” published Jul. 3, 2008, to Zhang et al.
Banerjee et al., “Nanotubular metal-insulator-metal capacitor arrays for energy storage,” Nature Nanotechnology, 2009, 4, 292-296 (“Banerjee 2009”).
Bard et al., Electrochemical Methods: Fundamentals and Applications, 2000, (Wiley, 2^{nd} Ed.), 99-231 (“Bard 2000”).
Brodie, “On the Atomic Weight of Graphite,” Phil. Trans. R. Soc. Lond., 1859, 149, 24931 (“Brodie 1859”).
Choi, et al., “High performance of a solid-state flexible asymmetric supercapacitor based on graphene,” Nanoscale, 2012, 4, 4983-8 (“Choi 2012”).
Choi et al., “Facilitated ion transport in all-solid-state flexible supercapacitors,” ACS Nano, 2011, 5, 7205-13 (“Choi 2011”).
Du et al., “Enhanced electrochemical capacitance of polyaniline/graphene hybrid nanosheets with graphene as template,” Composites Part B, 2013, 53, 376-81 (“Du 2013”).
Hatchett et al., “Acid doping of polyaniline: spectroscopic and electrochemical studies,” J Phys Chem B, 1999, 103, 10992-8 (“Hatchett 1999”).
Hu et al., “Flexible solid-state paper based carbon nanotube supercapacitor,” Appl Phys Lett, 2012, 100, 104103 (“Hu 2012”).
Huang et al., “Theoretical Model for Nanoporous Carbon Supercapacitors,” Angewandte Chemie International Edition, 2008, 47 (3) 520-524 (“Huang 2008”).
Jiang et al., Large-Scale Uniform α-Co(OH)₂ Long Nanowire Arrays Grown on Graphite as Pseudocapacitor Electrodes,” ACS Appl. Mater. Interfaces, 2011, 3 (1), 99-103 (“Jiang 2011”).
Jung et al., Transparent, flexible supercapacitors from nano-engineered carbon films,” Sci Rep—UK, 2012, 2, 773 (“Jung 2012”).
Kajdos et al., “Tailoring the Pore Alignment for Rapid Ion Transport in Microporous Carbons,”J. Am. Chem. Soc., 2010, 132 (10), 3252-3253 (“Kajdos 2010”).
Kang, et al., “All-solid-state flexible supercapacitors fabricated with bacterial nanocellulose papers, carbon nanotubes, and triblock-copolymer ion gels,” ACS Nano, 2012, 6, 6400-6 (“Kang 12012”).
Kang et al., “All-solid-state flexible supercapacitors based on papers coated with carbon nanotubes and ionic-liquid-based gel electrolytes,” Nanotechnology, 2012, 23, 065401 (“Kang II 2012”).
Kuila et al., “Vertically oriented arrays of polyaniline nanorods and their super electrochemical properties,” Chem. Commun., 2009, 5749-5751 (“Kuila 2009”).
Kumar et al., “Polyaniline-Grafted Reduced Graphene Oxide for Efficient Electrochemical Supercapacitors,” ACS Nano, 2012, 6 (2), 1715-1723 (“Kumar 2012”).
Largeot et al., “Relation between the Ion Size and Pore Size for an Electric Double-Layer Capacitor,” J. Am. Chem. Soc., 2008, 130 (9), 2730-2731 (“Largeot 2008”).
Lee et al., “Carbon Nanotube/Manganese Oxide Ultrathin Film Electrodes for Electrochemical Capacitors,” ACS Nano, 2010, 4 (7), 3889-3896 (“Lee 2010”).
Li et al., “Three-dimensional ordered nanostructures for supercapacitor electrode,” Electrochimica Acta, 2013, 99, 278-284 (“Li 2013”).
Q. Li et al., “Design and Synthesis of MnO₂/Mn/MnO₂ Sandwich-Structured Nanotube Arrays with High Supercapacitive Performance for Electrochemical Energy Storage,” Nano Lett., 2012, 12 (7), 3803-3807 (“Q. Li 2012”).
X. Li et al., “Facile synthesis and super capacitive behavior of SWNT/MnO₂ hybrid films,” Nano Energy, 2012, 1 (3), 479-487 (“X Li 2012”).
Li et al., “Anchoring alpha-manganese oxide nanocrystallites on multi-walled carbon nanotubes as electrode materials for supercapacitor,” Journal of Nanoparticle Research, 2010, 12 (7), 2349-2353 (“Li 2010”).
Li et al., “Facile Fabrication of Uniform Core-Shell Structured Carbon Nanotube-Polyaniline Nanocomposites,” J. Phys. Chem. C, 2009, 113 (14), 5502-5507 (“Li 2009”).
Liang et al., “Direct Access to Metal or Metal Oxide Nanocrystals Integrated with One-Dimensional Nanoporous Carbons for Electrochemical Energy Storage,” J. Am. Chem. Soc., 2010, 132 (42), 15030-15037 (“Liang 2010”).
Liu et al., “Graphene-Based Supercapacitor with an Ultrahigh Energy Density,” Nano Lett., 2010, 10 (12), 4863-4868 (“Liu 2010”).
Liu et al., “Templateless Assembly of Molecularly Aligned Conductive Polymer Nanowires: A New Approach for Oriented Nanostructures,” Chemistry—A European Journal, 2003, 9 (3), 604-611 (“Liu 2003”).
Lu et al., “Facile synthesis of large-area manganese oxide nanorod arrays as a high-performance electrochemical supercapacitor,” Energy Environ. Sci., 2011, 4, 2915-2921 (“Lu 2011”).
Lu et al., “High performance electrochemical capacitors from aligned carbon nanotube electrodes and ionic liquid electrolytes,” Journal of Power Sources, 2009, 189 (2), 1270-1277 (“Lu 2009”).
Miller et al., “Graphene Double-Layer Capacitor with ac Line-Filtering Performance,” Science, 2010, 329 (5999), 1637-1639 (“Miller 2010”).
Salari et al., “Enhancement of the capacitance in TiO₂ nanotubes through controlled introduction of oxygen vacancies,” J. Mater. Chem., 2011, 21, 5128-5133 (“Salari 2011”).
Sheng et al., “Ultrahigh-rate supercapacitors based on eletrochemically reduced graphene oxide for ac line-filtering,” Scientific Reports, 2012, 2, 247 (“Sheng 2012”).
Skinner et al., “Theory of volumetric capacitance of an electric double-layer supercapacitor,” Phys. Rev. E, 2011, 83, 056102 (“Skinner 2011”).
Smalley, “Future Global Energy Prosperity: The Terawatt Challenge,” MRS Bulletin, June 2009, 30 (06), 412-417 (“Smalley 2009”).
Stoller et al., “Graphene-Based Ultracapacitors,” Nano Lett., 2008, 8 (10), 3498-3502 (“Stoller 2008”).
Wang et al., “Hybrid projection methods for a bifunction and relatively asymptotically nonexpansive mappings,” Fixed Point Theory and Applications 2013, 2013, 294-303 (“Wang 2013”).
D. Wang et al., “Ternary Self-Assembly of Ordered Metal Oxide-Graphene Nanocomposites for Electrochemical Energy Storage,” ACS Nano, 2012, 4 (3), 1587-1595 (“D. Wang 2010”).
R. Wang et al., “Understanding the Protonation of Polyaniline and Polyaniline-Graphene Interaction,” J. Physc. Chem C, 2012, 116 (24), 13120-13126 (“R. Wang 2012”).
Wang et al., “An all-solid-state flexible micro-supercapacitor on a chip,” Adv Energy Mater, 2011, 1, 1068-72 (“Wang 2011”).
Wang et al., “Conducting Polyaniline Nanowire Arrays for High Performance Supercapacitors,” J. Phys. Chem. C, 2010, 114 (17), 8062-8067 (“Wang 2010”)
Wei et al., “A reduced graphene oxide based electrochemical biosensor for tyrosine detection, Nanotechnology, 2012; 23, 335707 (“Wei 2012”).
Winter et al., “What are batteries, fuel cells, and supercapacitors?” Chem Rev, 2004, 104, 4245-69 (“Winter 2004”).
Wu et al., “Supercapacitors Based on Flexible Graphene/Polyaniline Nanofiber Composite Films,” ACS Nano, 2010, 4 (4), 1963-1970 (“Wu 2010”).
Xia et al., “Porous Hydroxide Nanosheets on Preformed Nanowires by Electrodeposition: Branched Nanoarrays for Electrochemical Energy Storage,” Chem. Mater., 2012, 24 (19), 3793-3799 (“Xia 2012”).
Xiao, et al., “Fiber-based all-solid-state flexible supercapacitors for self-powered systems,” ACS Nano, 2012, 6, 9200-6 (“Xiao 2012”).
Xu et al., “Hierarchical Nanocomposites of Polyaniline Nanowire Arrays on Graphene Oxide Sheets with Synergistic Effect for Energy Storage,” ACS Nano, 2010, 4 (9), 5019-5026 (“Xu 2010”).
Xue et al., “Structure-Based Enhanced Capacitance: In Situ Growth of Highly Ordered Polyaniline Nanorods on Reduced Graphene Oxide Patterns,” Advanced Functional Materials, 2012, 22 (6), 1284-1290 (“Xue 2012”).
Yang et al., “A high-performance graphene oxide-doped ion gel as gel polymer electrolyte for all-solid-state supercapacitor applications,” Adv Funct Mater, 2013, 23, 3353-60 (“Yang 2013”).
Yuan et al., “Flexible solid-state supercapacitors based on carbon nanoparticles/MnO₂ nanorods hybrid structure,” ACS Nano, 2012, 6, 656-61 (“Yuan 2012”).
Zhu et al., “Carbon-Based Supercapacitors Produced by Activation of Graphene,” Science, 2011, 332 (6037), 1537-1541 (“Zhu 2011”).

The disclosures of all patents, patent applications, and publications cited herein are hereby incorporated herein by reference in their entirety, to the extent that they provide exemplary, procedural, or other details supplementary to those set forth herein.

What is claimed is:

1. A composition comprising a plurality of stacked polymer nanowire arrays interconnected with graphene sheets.

2. The composition of claim 1, wherein the graphene sheets are mono-layer graphene sheets.

3. The composition of claim 1, wherein the stacked polymer nanowire arrays in the plurality of stacked nanowire arrays and the graphene sheets are positioned alternatively.

4. The composition of claim 1, wherein the stacked polymer nanowire arrays comprise polyaniline nanowire arrays.

5. The composition of claim 1, wherein the stacked polymer nanowire arrays comprise polymer nanowires having diameters between 13.5 to 50 nm.

6. The composition of claim 5, wherein the stacked polymer nanowire arrays comprise polymer nanowires having diameters between 20 to 30 nm.

7. The composition of claim 5, wherein the stacked polymer nanowire arrays comprise polymer nanowires having diameters between 40 to 50 nm.

8. The composition of claim 1 further comprising polyvinyl alcohol.

9. A device comprising a material comprising a plurality of stacked polymer nanowire arrays interconnected with graphene sheets.

10. The device of claim 9, wherein the device is operable for simultaneously having (a) an energy density at least 75 Wh/Kg and (b) a power density of at least 1500 W/Kg.

11. The device of claim 9, wherein the device is operable for simultaneously having (a) an energy density between 75 Wh/Kg and 150 Wh/Kg and (b) a power density of between 1500 W/Kg and 65,000 W/Kg.

12. The device of claim 9, wherein the device is operable as a supercapacitor.

13. The device of claim 9, wherein the device further comprises an aqueous electrolyte.

14. The device of claim 9, wherein the device further comprises an organic electrolyte.

15. The device of claim 14, wherein the device is operable for having a specific capacitance between 75 F/g and 250 F/g.

16. The device of claim 9, wherein the stacked polymer nanowire arrays comprise polyaniline nanowire arrays.

17. The device of claim 9, wherein the material further comprises polyvinyl alcohol.

18. A method comprising:
(a) preparing a first layer of a polymer nanowire array;
(b) depositing a first layer of graphene oxide on the first layer of the polymer nanowire array to form a first material;
(c) fabricating a second layer of the polymer nanowire array on the first material to form a second material;
(d) depositing a second layer of graphene oxide on the second material to form a third material;
(e) repeating steps (c) and (d) to form a composite material having n-layers of the polymer nanowire array, wherein n is at least 2;
(f) reducing the deposited layers of graphene oxide to graphene sheets to form a stacked polymer nanowire array/graphene material, wherein the stacked polymer nanowire arrays are interconnected with the graphene.

19. The method of claim 18, wherein each of the layers of the polymer nanowire arrays comprise polyaniline.

20. The method of claim 18, wherein n is 3.

21. The method of claim 18, wherein the step of depositing the n layer of the polymer nanowire array in-situ reduces the n−1 layer of the graphene oxide.

22. The method of claim 18 further comprising incorporating the stacked polymer nanowire arrays/graphene material in a device with an electrolyte.

23. The method of claim 22, wherein the device is used as a supercapacitor.

24. The method of claim 23, wherein the supercapacitor simultaneously has (a) an energy density at least 75 Wh/Kg and (b) a power density of at least 1500 W/Kg.

25. The method of claim 18 further comprising:
(a) immersing the stacked polymer nanowire array/graphene material in an liquid electrolyte;
(b) removing the stacked polymer nanowire array/graphene material from the liquid electrolyte to form a hybrid material comprising the stacked polymer nanowire array/graphene material coated and a solid electrolyte.

26. The method of claim 25, wherein the solid electrolyte comprises polyvinyl alcohol.

27. The method of claim 25, wherein the liquid electrolyte comprises polyvinyl alcohol, H₃PO₄, and Nafion.

28. The method of claim 25 further comprising drying the stacked polymer nanowire array/graphene material after the step of removing the stacked polymer nanowire array/graphene material from the liquid electrolyte.

29. The method of claim 18, wherein each of the polymer nanowire arrays comprises polymer nanowires having diameters between 13.5 to 50 nm.

30. The method of claim 29, wherein each of the polymer nanowire arrays comprises polymer nanowires having diameters between 40 to 50 nm.
